(19) United States
(12) Patent Application Publication
(10) Pub. No.: US 2019/0314864 A1
(43) Pub. Date: Oct. 17, 2019

(54) Floor Scraper

(71) Applicant: Monty Cazier, Palestine, TX (US)

(72) Inventor: Monty Cazier, Palestine, TX (US)

(21) Appl. No.: 16/299,265

(22) Filed: Mar. 12, 2019

Related U.S. Application Data
(60) Provisional application No. 62/656,532, filed on Apr. 12, 2018.

(51) Int. Cl. B08B 1/00; B25G 3/02

(52) U.S. Cl. CPC B08B 1/005; B25G 3/02

(57) ABSTRACT

No squat floor scraper 2 that fits on the handle 10 of an op or broom is disclosed. Our handheld scraper 2 can be converted into a long-handle 10 floor scraper 2 using the end of a mop or broom handle 10 as it is designed to fit over most of the brooms and mops being sold today.

### CROSS REFERENCE TO RELATED APPLICATIONS

This application claims priority to U.S. Provisional patent application 62/656,532, filed Apr. 12, 2018, the entirety of which is hereby incorporated by reference as if part of this specification.

### BACKGROUND OF THE INVENTION

The presently described invention relates to floor cleaning devices and more specifically, a floor scraper that is adapted to fit onto various tools to lengthen the reach of the scraper.

The invention eliminates having to squat, kneel or bend over while using. To use a handheld scraper on a floor requires the user to squat, bend over or kneel down in order to scrape something from a floor surface, which can be painful and injurious to a user's back and knees.

The described scraper can be converted into a long-handle floor scraper using the end of a mop or broom handle, as it is designed to fit over most of the brooms and mops being sold today. This new scraper can be used to reach areas that are difficult to reach or in high places. It could for example be used to scrape dirt and grime off car windshields, cleaning walls, removing wallpaper, or windows

### SUMMARY OF THE INVENTION

The claimed scraper eliminates having to squat, kneel or bend over to use a hand scraper on a floor by use of the claimed scraper that, in one embodiment includes a means for scraping attached to a handle, the handle including a neck, a mid-shaft area connected to the neck and a larger area connected to the mid shaft area. The neck has a smaller end and a terminal ending, the smaller end and the terminal ending having about equal diameters, the mid-shaft area has a smaller end, which is directly connected to the neck and a larger end, which is directly connected to the larger area of the handle, the mid-shaft area is tapered such that the smaller end has a diameter that is less than the diameter of the larger end, the mid-shaft area gradually increasing in diameter from the smaller end toward the larger end at a rate that is higher than the increasing diameter with the neck between the smaller end and the terminal ending, and the terminal ending has a smaller diameter than the larger end of the mid-shaft area.

### BRIEF DESCRIPTION OF THE DRAWINGS

FIG. 1 is an exemplary view of one embodiment of the invention;

FIG. 2 is a side diagonal perspective view of the handle of one embodiment of the invention;

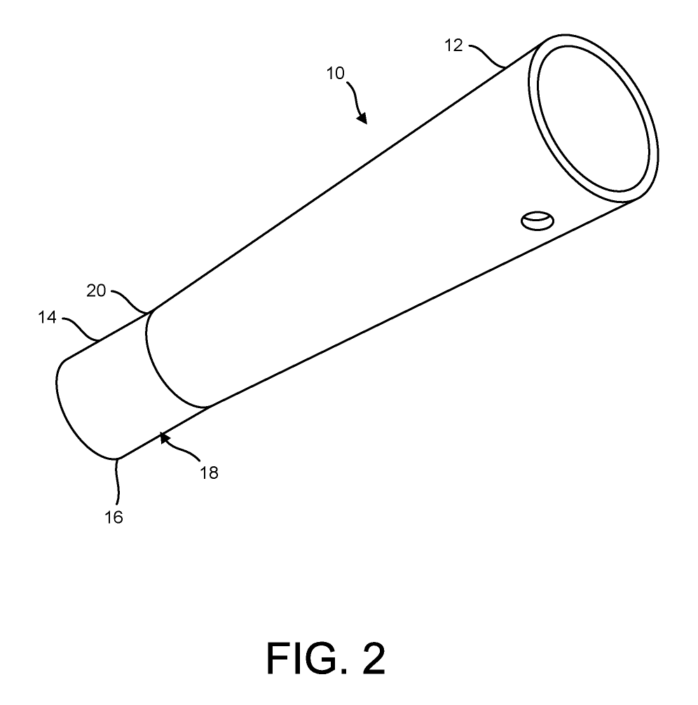

FIG. 3 is a cross-sectional view of the inner walls of the handle of one embodiment of the invention;

FIG. 4 is a top, cross-sectional view of the handle of one embodiment of the invention;

FIG. 5 is an illustrative view of one embodiment of the handle of the invention; and

FIG. 6 is an illustrative view of the handle of on embodiment of the invention.

### DETAILED DESCRIPTION OF THE INVENTION

The described and claimed hand scraper 2 is designed to fit over the handle of most brooms or mops being sold today. This allows our invention to change from and hand scraper to a long handle floor scraper. With reference to the Figures, scraper 2 comprises a means for scraping 6 attached to a novel handle 10, handle 10 comprises neck 18, mid-shaft area 30 connected to neck 18, and larger area 40, connected to mid shaft area 30, wherein neck 18 has a smaller end 32 and a terminal ending 34, smaller end 32 and the terminal ending 34 having about equal diameters. Mid-shaft area 30 has a smaller end 32, which is directly connected to neck 18 and larger end 42 of larger area 40. Mid-shaft area 30 is tapered such that smaller end 32 has a diameter that is less than the diameter of larger end 34, and gradually increases in diameter from smaller end 32 toward larger end 34 at a rate that is higher than the increasing diameter within neck 18, between the smaller end 16 and the terminal ending 20.

Terminal ending 20 has a smaller diameter than the larger end 34 of the mid-shaft area 30. In specific embodiments, scraper 2 comprises metal blade 4, plastic head 6, which is formed in two parts in which metal blade 4 is held in place with two screws, or other attachment means, single blade guard 6 made of plastic which fits over the sharp edge 5 of blade 4. Handle 10 is attached to plastic head 6 with metal blade 4. Metal blade 4 fits into plastic head 6 and is held with two screws. Plastic guard 6 fits over sharp edge 5 of the blade 4. Handle 10 is fastened to the head forming hand scraper 2.

Metal blade 4 is held within a two-piece plastic head and held securely by two bolts and nuts, or other attachment means. Blade guard 6 is made to fit over sharp edge 5 of blade 4. The head is now attached to handle 10, which formed of a plastic adapted to restrain and secure tools within the walls of handle 10 using friction force alone.

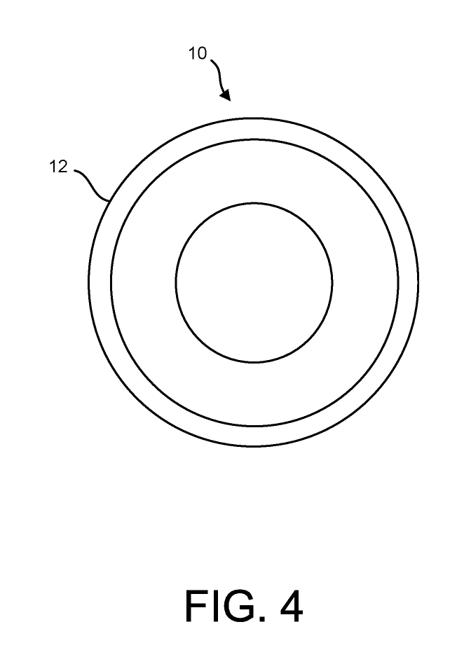

Creating the invention will require the making of three molds. One to form a two-piece plastic head a second to form a handle 10 to certain dimensions. With reference to the Figures, handle 10 will be conical in shape about five inches in length. With reference to FIG. 4, handle 10 includes larger end 12 and top end 14. End 12 and end 14 are measured based on their relative diameters. As used herein, the term “diameter” refers to the inside diameter of the element referred to unless stated otherwise. The inside diameter of the larger end of the handle 10 will be about 1.25 inches in diameter and will gradually and generally narrow down to the top end 14 of the handle 10.

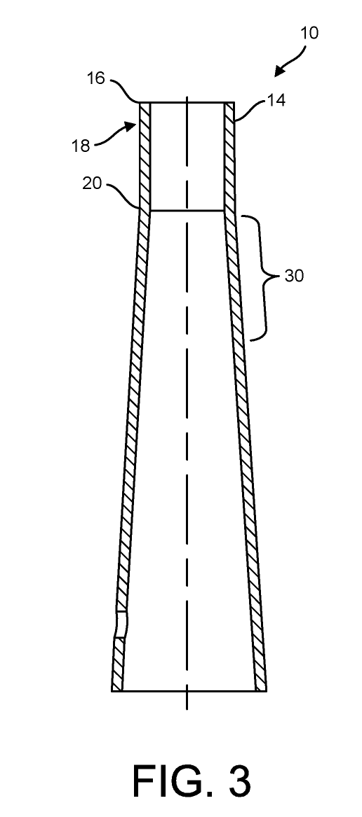

The tapering of handle 10 is unique because of its varying degrees of narrowing of handle 10 between end 16 and end 12. With reference to FIG. 3, neck 18 is formed near top end 14 as us formed by smaller end 16 and a terminal ending 20. Smaller end 16 and terminal ending 20 have equal diameters. Neck 18 is designed to capture and retain smaller handles like brooms and mops using friction alone.

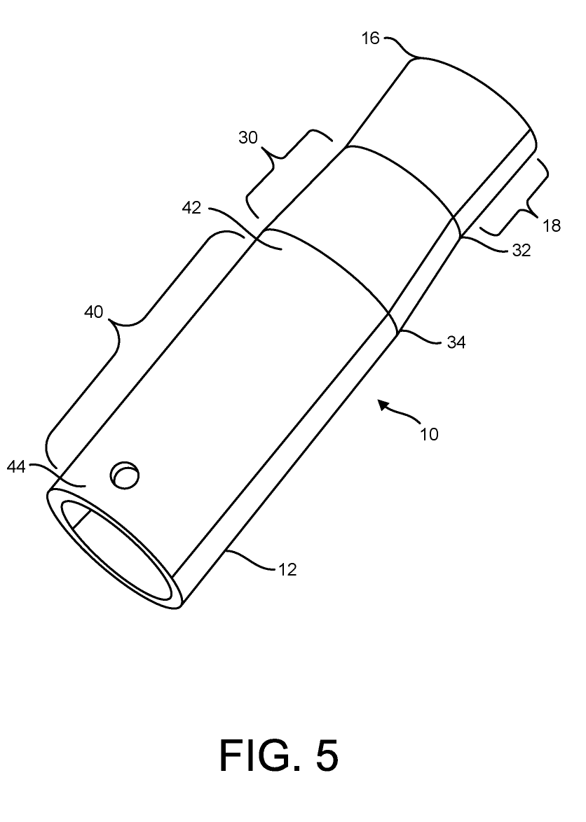

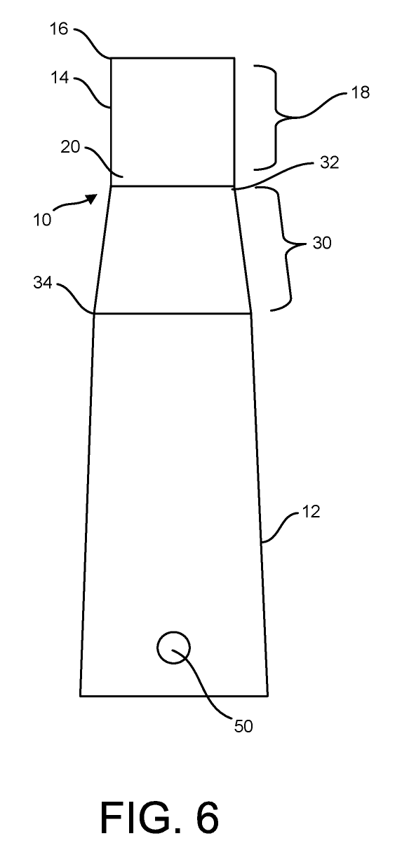

Handle 10 also includes mid-shaft area 30, which lies between neck 18 and end 12. Mid-shaft area 30 comprises a smaller end 32, which is directly connected to neck 18 and larger end 34, which is directly connected to the remaining portion of handle 10. Like neck 18, mid-shaft area 30 is tapered such that smaller end 32 has a diameter that is less than the diameter of larger end 18. With reference to FIGS. 5 and 6, mid-shaft area 30 gradually increases in diameter from smaller end 32 toward larger end 18 at a rate that is higher than the increasing diameter between end 16 and terminal ending 20. As a result, terminal ending 20 has a smaller diameter than larger end 34. This difference in diameter between neck 18 and mid-shaft area 30 allows various sizes of tools with rounded handles to fit snugly inside handle 10 using friction alone.

Larger area 40 of handle 10 is gradually tapered in a manner that is less extreme than neck 18 and mid-shaft area 30. Larger area 40 has a first end 40, which has a diameter that is about the same as the diameter of its second end 44. Specifically, the diameter of terminal ending 20 is consistently and gradually less than the diameter of end 16 so that tools with diameters larger than the inside diameter of neck 18, will fit into and remain inside handle 10.

In a specific embodiment of the invention, handle 10 comprises end 16 has a diameter of about 0.72 inches, end 34 has a diameter of about 1.25 inches and end 12 has a diameter of about 1.25 inches. In another specific embodiment of handle 10, handle is about 5 inches long, neck 18 is about 1 inch long while neck 18 and mid-shaft area 30 are about 2 inches long, when combined.

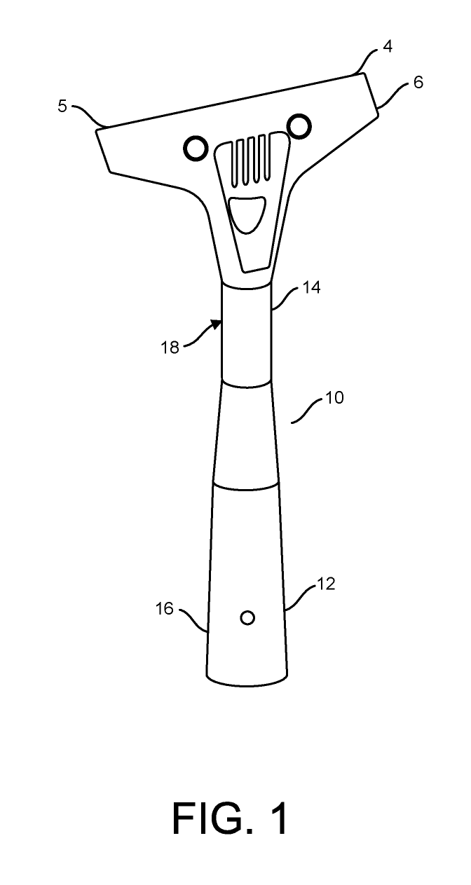

With reference to FIG. 1 handle 10 may include an aperture 50 or other hanging means about end 12, within a wall of handle 10.

Scraper 2 is may be made by various known means, and in one embodiment is made using molding. With reference to FIG. 1, a mold is employed to form a blade guard 6. Two bolts with nuts, or other attachment means are employed to hold the metal blade 4 in place. Metal blade 4 will function as the scraper 2 and in specific embodiments of the invention will be 4 inches in length by ½ inch in width. The metal blade 4 is inserted into the two-piece plastic head and held securely with the two bolts and nuts. The head is then attached to the handle 10 by being inserted into the narrow end of the handle 10.

All the components are necessary to form a scraper 2 with a sharp blade 4 and which has a uniquely designed handle 10 which can be attached to most broom or mop handle 10 by a using a push and twist motion to hold the scraper 2 on the broom or mop handle 10.

This new invention is really rather easy to use. A user obtains a broom or mop with a handle, which will fit inside the walls of handle 10 of scraper 2. By using a push and twist motion to engage using friction forces, scraper 2 is forced over the broom or mop handle 10 thereby converting the scraper 2 into a long handle floor scraper 2 without making the attachment permanent.

One of skill in the art would understand that various modification may be made to the embodiment of the invention described herein without departing from the spirit and scope of the invention. Obvious modification are anticipated to be within the scope of this invention.

I claim:

1. A scraper comprising:
a means for scraping attached to a handle, the handle comprising
a neck;
a mid-shaft area connected to the neck; and
a larger area connected to the mid shaft area; wherein
the neck has a smaller end and a terminal ending,
the smaller end and the terminal ending having about equal diameters;
the mid-shaft area has a smaller end, which is directly connected to the neck and a larger end, which is directly connected to the larger area of the handle,
the mid-shaft area is tapered such that the smaller end has a diameter that is less than the diameter of the larger end,
the mid-shaft area gradually increasing in diameter from the smaller end toward the larger end at a rate that is higher than the increasing diameter with the neck between the smaller end and the terminal ending, and
the terminal ending has a smaller diameter than the larger end of the mid-shaft area.

2. The scraper of claim 1 wherein the handle further comprises a hanging means.

3. The scraper of claim 1 wherein the hanging means in an aperture within a wall of the handle.

4. The scraper of claim 1 wherein the means for scraping is a scraper.

5. The scraper of claim 1 wherein the means for scraping comprises a replaceable blade.

6. The scraper of claim 1 wherein the replaceable blade is about four inches long.

7. The scraper of claim 1 wherein the scraper is made a material that is adapted to retain a tool within an inside wall of the handle using only friction.
